(19) United States
(12) Patent Application Publication
(10) Pub. No.: US 2025/0043134 A1
(43) Pub. Date: Feb. 6, 2025

(54) COMPOSITE PRODUCT

(71) Applicant: Woodcomposite Sweden AB, Hyltebruk (SE)

(72) Inventors: Roger BERGSTRÖM, Hyltebruk (SE); Fredrik KÄLLSTRÖM, Hyltebruk (SE); Patricia ODDSHAMMAR, ÄNGELHOLM (SE)

(73) Assignee: Woodcomposite Sweden AB, Hyltebruk (SE)

(21) Appl. No.: 18/717,592

(22) PCT Filed: Nov. 10, 2022
(86) PCT No.: PCT/IB2022/060817

§ 371 Date: Jun. 7, 2024

(30) Foreign Application Priority Data
Dec. 13, 2021 (SE) 2151521-8

(51) Int. Cl. C09D 5/28; B05D 5/06; B05D 7/10; C09D 7/40; C09D 7/61; C09D 123/06; C09D 123/12; C09D 167/00

(52) U.S. Cl. CPC C09D 5/28; B05D 5/061; B05D 7/10; C09D 7/61; C09D 7/70; C09D 123/06; C09D 123/12; C09D 167/00; B05D 2203/20

(57) ABSTRACT

A composite product includes a solid wood component and a coating layer on at least one side of the solid wood component. The at least one side of the solid wood component has a wood grain. The coating layer includes at least one thermoplastic polymer and non-spherical pigment particles distributed within the coating layer. The coating layer has a surface pattern at least partly mimicking the wood grain.

### TECHNICAL FIELD

The present embodiments generally relate to composite products, and in particular to such composite products comprising a solid wood component coated with a coating layer comprising at least one thermoplastic polymer and non-spherical pigment particles and a method of producing such composite products.

### BACKGROUND

Many wood species that are untreated are very susceptible to influences caused by the external environment. Untreated wood that is exposed to moisture and/or soil for sustained periods of time will become weakened by attacks by microorganisms and/or insects. It is therefore important to treat the less durable wood in order to increase its resistance against moisture and attacks by microorganisms and/or insects. In addition, wood which is exposed to ultra violet (UV) radiation is susceptible to discoloration and deterioration.

There are a number of different treatments to increase the resistance of wood, including chemical treatment with, for instance, fungicides and heat treatment to thermally modify the wood and remove certain organic compounds found in the wood.

Another way to protect solid wood products is by applying paint coatings to the surface of the wood. These paint coatings can be applied by hand or in a factory environment and are normally based on first applying a base (primer) coating and then one or two additional over coat layers to build a protective film on the surface of the wood. This kind of paint coating is, however, susceptible to changing climatic conditions and over time erodes, cracks or peels from the wood, leading to a need for periodic remedial maintenance.

Other known methods include applying a layer of polyvinyl chloride (PVC) polymer on or around a solid wood product as described in WO 2007/057029. Such plastic coatings of solid wood products may include pigments or dyes to color the plastic coatings, typically in a single substantially uniform color. The solid wood products, however, have an artificial visual appearance that is far from the natural wood grain of the solid wood core.

There is therefore a need for solid wood products having surface coatings that present a visual effect mimicking the wood grain of the wood core.

### SUMMARY

It is a general objective to provide a composite product comprising a solid wood component and a coating layer on at least one side of the solid wood component and where the coating layer has a surface pattern mimicking natural wood grain.

This and other objectives are met by embodiments of the present invention.

The present invention is defined in the independent claims. Further embodiments of the invention are defined in the dependent claims.

An aspect of the invention relates to a composite product comprising a solid wood component and a coating layer on at least one side of the solid wood component. The at least one side of the solid wood component has a wood grain. The coating layer comprises at least one thermoplastic polymer and non-spherical pigment particles distributed within the coating layer. The coating layer has a surface pattern at least partly mimicking the wood grain.

Another aspect of the invention relates to method of producing a composite product. The method comprises extruding a material comprising at least one thermoplastic polymer and non-spherical pigment particles onto at least one side of a solid wood component having a wood grain at an extrusion pressure selected to form, on the at least one side, a coating layer having a surface pattern at least partly mimicking the wood grain.

The coating layer applied, such as extruded, on the solid wood component of the composite product mimics natural wood grain and thereby has a visually appealing appearance. The surface pattern of the coating layer is formed by non-spherical pigment particles orienting differently in the coating layer depending on the compressibility of the underlying section of the solid wood component. These differences in distribution of pigment orientation in the coating layer presents a visual pattern that at least partly mimics the wood grain of the solid wood component, onto which the coating layer is applied, such as extruded.

### BRIEF DESCRIPTION OF THE DRAWINGS

The embodiments, together with further objects and advantages thereof, may best be understood by making reference to the following description taken together with the accompanying drawings, in which:

FIG. 1A is a cross-sectional view of a composite product according to an embodiment;

FIG. 1B is a cross-sectional view of the composite product taken along the line A-A in FIG. 1A;

FIG. 1C is a magnification of the portion of the composite product in box B in FIG. 1A;

FIG. 1D is a magnification of the portion of the composite product in box C in FIG. 1B;

FIG. 2 is a schematic illustration of an extruder for producing a composite product according to the embodiments.

FIG. 3 is a flow chart illustrating a method of producing a composite product according to an embodiment;

FIG. 4 is a flow chart illustrating an additional, optional step of the method illustrated in FIG. 3 according to an embodiment;

FIG. 5 is a photography of a composite product according to the invention; and

FIG. 6 is a photography of a reference composite product.

### DETAILED DESCRIPTION

The present embodiments generally relate to composite products, and in particular to such composite products comprising a solid wood component coated with a coating layer comprising at least one thermoplastic polymer and non-spherical pigment particles and a method of producing such composite products.

The composite products of the invention have the benefits of protecting the wood core, i.e., the solid wood component, from the external environment including ambient conditions, such as precipitation and UV radiation, and attacks by microorganisms and/or insects. This protective effect is achieved by a coating layer applied onto the solid wood component. Such coating layers are per se known in the art and are generally suffering from an artificial visual appearance that is far from the appearance of wood in general. These coating layers then generally have a color defined by the components of the coating layer including any solid color pigments, often in the form of absorption pigments and/or white pigments, contained therein. This visual appearance, see FIG. 6, is far from the natural wood grain surface appearance of wood components.

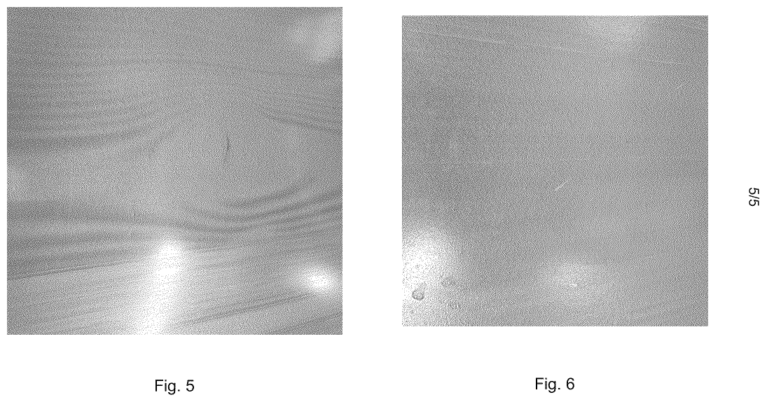

The present invention is based on the unexpected discovery that it is possible to produce a coating layer on a solid wood component and where the coating layer at least partly mimics the wood grain of the solid wood component, see FIG. 5, by the use of non-spherical pigment particles and applying pressure onto the solid wood component during the coating process, such as by extruding the coating layer onto the solid wood component, to cause a compression of sections of the solid wood component. The combination of non-spherical pigment particles and at least partly compressing the solid wood component is believed to cause a local reorientation of the non-spherical pigment particles in connection with the compressed sections of the solid wood components. The non-spherical pigment particles in connection with these compressed sections thereby have an average orientation that is different from an average orientation of non-spherical pigment particles in connection with non-compressed or less compressed sections of the solid wood component. This means that the orientation of the non-spherical pigment particles in the coating layer differs throughout the extension of the coating layer and is at least partly defined by the compressibility of the underlying sections of the solid wood component.

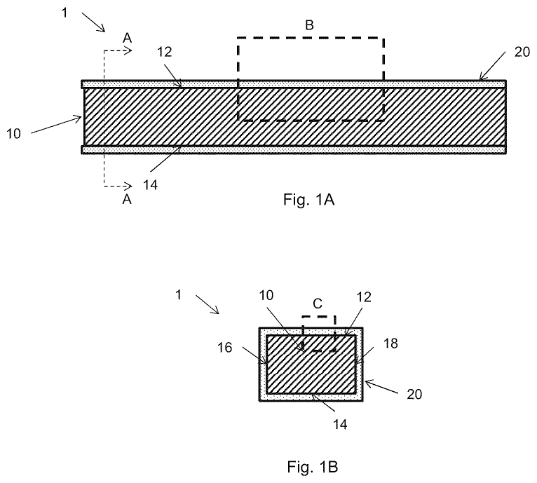

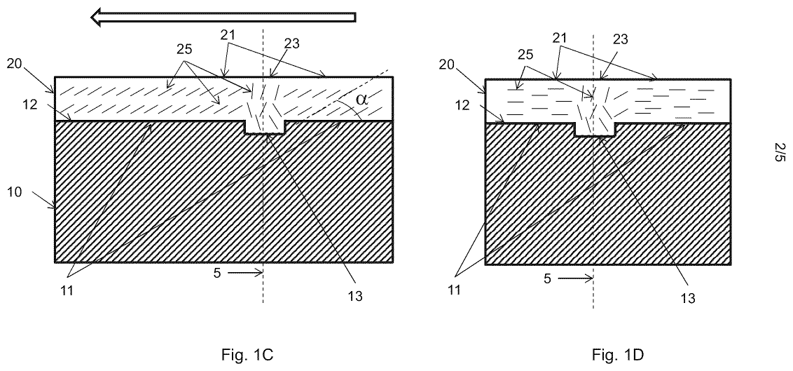

An aspect of the invention relates to a composite product 1, see FIGS. 1A-1D. The composite product 1 comprises a solid wood component 10 and a coating layer 20 on at least one side 12, 14, 16, 18 of the solid wood component 10. The at least one side 12, 14, 16, 18 of the solid wood component 10 has a wood grain. The coating layer 20 comprises at least one thermoplastic polymer and non-spherical pigment particles 25 distributed within the coating layer 20. The coating layer 20 has a surface pattern at least partly mimicking the wood grain.

The coating layer 20 of the invention comprises non-spherical pigment particles 25 distributed therein. These non-spherical pigment particles 25 will reflect incident light dependent on the particular orientation of the non-spherical pigment particles 25 in the coating layer 20. This is in clear difference to spherical pigment particles that have a substantial same light absorption or reflection independent of orientation of the spherical pigment particles relative to the incoming light. This property of the non-spherical pigment particles 25 is utilized in the invention to produce a coating layer 20 that is capable of at least partly mimicking the wood grain, also referred to as wood graining or grain pattern, of the coated solid wood component 10. As a consequence, annual or growth rings and other visual patterns in the at least one side 12, 14, 16, 18 of the solid wood component, such as knots, or at least a portion thereof, become visible in the coating layer 20.

In an embodiment, the wood grain comprises or is formed by sections 13 with a comparatively higher compressibility and sections 11 with a comparatively lower compressibility, see FIGS. 1C and 1D. The coating layer 20 comprises first sections 23 aligned, along an axis 5 perpendicular to the at least one side 12, 14, 16, 18, with the sections 13 with the comparatively higher compressibility and second sections 21 aligned, along the axis 5, with the sections 11 with the comparatively lower compressibility. In such an embodiment, non-spherical pigment particles 25 in the first sections 23 of the coating layer 20 have a different average orientation in the coating layer 20 than non-spherical pigment particles 25 in the second sections 21 of the coating layer 20. Hence, in this embodiment, non-spherical pigment particles 25 in the first sections 23 of the coating layer 20 adjacent to or in vicinity of the sections 13 of the solid wood component 10 with the comparatively higher compressibility have a different average orientation in the coating layer 20 as compared to non-spherical pigment particles 25 in the second sections 21 of the coating layer 20 adjacent to or in vicinity of the sections 11 of the solid wood component 10 with the comparatively lower compressibility. This means that the surface pattern of the coating layer 20 is formed by the non-spherical pigment particles 25 in the first sections 23 of the coating layer 20 having a different average orientation in the coating layer 20 than non-spherical pigment particles 25 in the second sections 21 of the coating layer 20. As mentioned above, the wood grain comprises these sections 11, 13 with different compressibility. In more detail, the wood grain of the at least one side 12, 14, 16, 18 of the solid wood component 10 that is coated with the coating layer 20 comprises these sections 11, 13 with different compressibility. The first sections 23 of the coating layer 20 are the sections of the coating layer 20 aligned with the sections 13 with the comparatively higher compressibility when traveling along the axis 5 that is perpendicular to the at least one side 12, 14, 16, 18 and thereby normal to this at least one side 12, 14, 16, 18. Aligned along the axis 5 as used herein thereby imply that the first sections 23 are the sections of the coating layer 20 adjacent the sections 13 with the comparatively higher compressibility when traveling perpendicular to and from a general extension of the at least one side 12, 14, 16, 18 of the solid wood component 10 at these sections 13 with the comparatively higher compressibility and through the coating layer 20 to its outer surface, i.e., the surface of the coating layer 20 facing away from the solid wood component 10. Correspondingly, the second sections 21 are the sections of the coating layer 20 adjacent the sections 11 with the comparatively lower compressibility when traveling perpendicular to and from the surface of the at least one side 12, 14, 16, 18 of the solid wood component 10 at these sections 11 with the comparatively lower compressibility and through the coating layer 20 to its outer surface.

FIGS. 1C and 1D schematically illustrate this embodiment. In this case, in connection with applying, such as extruding, the coating layer 20 onto the side 12 of the solid wood component 10, the solid wood component 10 is exposed to a pressure, such as an extrusion pressure for a coating layer 20 applied using extrusion. The applied pressure may affect the solid wood component 10 to induce surface structures 11, 13 in the side 12. These surface structures 11, 13 are obtained since some sections 13 of the solid wood component are more compressible than other sections 11. As a consequence, the applied pressure may cause a local deformation of the side 12 in terms of the compressed sections 13 and non-compressed or less compressed sections 11. This compressibility of the solid wood component 10 is typically dependent on the wood grain of the solid wood component 10 with different compressibility of, for instance, latewood as compared to earlywood. Additionally, structures in the solid wood component 10, such as knots, generally have a different compressibility as compared to, for instance, heartwood. For instance, the sections 13 with the comparatively higher compressibility could comprise earlywood and the sections 11 with the comparatively lower compressibility could comprise latewood and possible knots.

Generally, the latewood will be denser than that formed early in the season, i.e., the earlywood. When examined under a microscope, the cells of dense latewood are seen to be very thick-walled and with very small cell cavities, while those in earlywood have thin walls and large cell cavities. The strength of the wood is in the walls, not the cavities. Hence, the sections of the wood comprising latewood are denser and have higher strength as compared to the sections of the wood comprising earlywood. This means that the sections of the solid wood component 10 that mainly consist of latewood have a comparatively lower compressibility as compared to the sections of the solid wood component 10 that mainly consist of earlywood. Visually, the latewood forms the darker parts of the annual ring of growth in the wood grain.

A typical solid wood component 10 generally does not contain merely two sections with different compressibility. In clear contrast, the compressibility of the solid wood component 10 may change gradually or abruptly when traveling along the at least one side 12, 14, 16, 18 of the solid wood component 10. Hence, various sections 11, 13 of the solid wood component 10 may become more or less compressed depending on the characteristics of the particular wood present at that section 11, 13.

In an embodiment, the coating layer 20 is applied, such as extruded, onto a single side 12, 14, 16, 18 of the solid wood component 10. For instance, the composite product 1 may, during use, be arranged so that only this single side 12, 14, 16, 18 is visible and/or faces the ambient environment and may thereby be exposed to the external environment. In another embodiment, the coating layer 20 is applied, such as extruded, onto multiple, i.e., at least two, sides 12, 14, 16, 18 of the solid wood component 10. For instance, the coating layer 20 could be applied, such as extruded, onto two opposite sides 12, 14 or 16, 18 of the solid wood component 10 or two neighboring or adjacent sides 12, 18 or 18, 14 or 14, 16 or 12, 16 of the solid wood component 10. It is also possible to apply, such as extrude, the coating layer 20 on three sides of the solid wood component 10 or all sides 12, 14, 16, 18 of the solid wood component 10, such as on four sides 12, 14, 16, 18 in the case of a solid wood component 10 with a quadratic or rectangular cross-section as shown in FIG. 1B.

The solid wood component 10 is typically in the form of an elongated piece of wood, such as a wood plank or board. The at least one side 12, 14, 16, 18, on which the coating layer 20 is applied, such as extruded, is then preferably an elongated or longitudinal side 12, 14, 16, 18 of the solid wood component 10. It is, however, also possible to apply, such as extrude, the coating layer 20 on one or both edges of the solid wood component 10. In such a case, the solid wood component 10 could be fully enclosed by the coating layer 20.

The at least one side 12, 14, 16, 18 of the solid wood component 10, onto which the coating layer 20 is applied, such as extruded, could be an unprocessed or untreated side or a processed or treated side. Unprocessed or untreated side as used herein is a side having a surface that is not processed or treated following cutting, i.e., have a general raw wood surface. A processed or treated side is a side having a processed or treated surface. An illustrative, but non-limiting, example of such a surface processing or treatment is trimming the at least one side 12, 14, 16, 18 using a thickness planer to form at least one trimmed side 12, 14, 16, 18. Also other types of surface treatments or processes are possible including heat treatment, forming surface structure, such as indentations or slots, in the at least one surface 12, 14, 16, 18, etc.

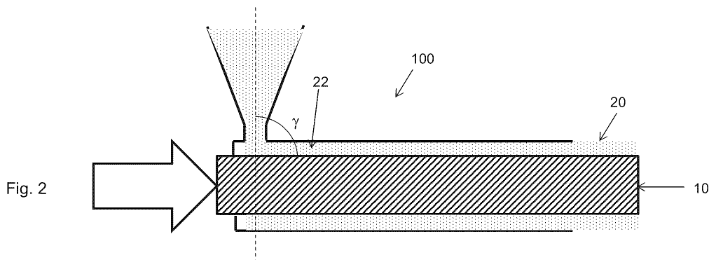

The coating layer 20 is preferably an extruded coating layer 20. Hence the coating layer 20 is preferably applied onto the at least one side 12, 14, 16, 18 of the solid wood component 10 by extrusion, which will be described further herein in connection with FIG. 2.

Producing the coating layer 20 by extrusion typically affects the general orientation of the non-solid pigment particles 25 in the formed coating layer 20. In more detail, when a material 22 comprising at least one thermoplastic polymer and non-spherical pigment particles 25, see FIG. 2, is extruded in an extruder 100 onto at least one side 12, 14, 16, 18 of a solid wood component 10 a majority of the non-spherical pigment particles 25 adjacent non-compressible or low-compressible sections 11 of the solid wood component 10 have substantially a same general orientation in the coating layer 20. These non-spherical pigment particles 25 are typically aligned or slightly angled relative to the direction (see arrow in FIG. 1C) of material flow during the extrusion process or are angled down towards the solid wood component 10 as shown for the non-spherical pigment particles 25 in the non-compressible or slight-compressible section 11 of the solid wood component 10 in FIG. 1C. This general orientation, typically tilting, of the non-spherical pigment particles 25 is caused by the direction of the flow of the material 22 from substantially perpendicular to or at least angled with a non-zero angle γ relative to the solid wood component 10 to turn and flow parallel to the solid wood component 10 inside the extruder 100, see FIG. 2. The non-spherical pigment particles 25 will thereby tilt forward towards the solid wood component 10. Typically, the coating layer 20 is cooled and solidified and the non-spherical pigment particles 25 thereby become locked or frozen in their orientation in the resulting coating layer 20. Hence, the general orientation of non-spherical pigment particles in sections 21 of the coating layer 20 aligned with, i.e., adjacent, the non-compressible or low-compressible sections 11 of the solid wood component 10 is typically tilted or angled relative to the at least one side 12, 14, 16, 18 of the solid wood component 10 with an angle α as shown in FIG. 1C. This angle α is from 0° up to 90° but is typically larger than 0° to get an average tilted orientation of the non-spherical pigment particles 25 in this section 21 of the coating layer 20.

FIG. 1D schematically illustrates a magnification of the portion of the composite product in box C in FIG. 1B. In this illustrative example, the non-spherical pigment particles 25 are assumed to be flake shaped, i.e., have comparatively larger length and width as compared to thickness. This means that the non-spherical pigment particles 25 that are slightly tilted in FIG. 1C are basically seen as substantially horizontal particles in the cross-sectional view of FIG. 1D.

This general alignment of a majority or at least a significant portion of the non-spherical pigment particles 25 in the sections 21 of the coating layer 20 aligned with non-compressible or low-compressible sections 11 of the solid wood component 10 is, however, not seen for the sections 23 of the coating layer 20 aligned with compressible sections 13 of the solid wood component 10. The extrusion process and the applied extrusion pressure compress these compressible sections 13 more than the non-compressible or low-compressible sections 11 of the solid wood component 10. As a consequence, indentations and other forms of depressions are thereby formed in the at least one side 12, 14, 16, 18 at these compressible sections 13 as indicated in FIGS. 1C and 1D. The material 22 with the non-spherical pigment particles 25 will then penetrate into these indentations and depressions in the at least one side 12, 14, 16, 18 of the solid wood component 10 and will thereby have a different distribution of pigment orientations as compared to the distribution of pigment orientations for the non-spherical pigment particles 25 in the sections 21 of the coating layer 20 aligned with the non-compressible or low-compressible sections 11 of the solid wood component 10. This difference in distribution of pigment orientations and difference in average orientation of non-spherical pigment particles 25 in the sections 23 of the coating layer 20 aligned with the compressible sections 13 of the solid wood component 10 as compared to non-spherical pigment particles 25 in the sections 21 of the coating layer 20 aligned with the non-compressible or low-compressible sections 11 of the solid wood component 10 causes the visual pattern of the coating layer 20 reflecting or at least partly mimicking the wood grain of the solid wood component 10 as shown in FIG. 5.

In an embodiment, the wood grain comprises sections 13 with a comparatively higher compressibility and sections 11 with a comparatively lower compressibility. The coating layer 20 comprises first sections 23 aligned, along an axis 5 perpendicular to the at least one side 12, 14, 16, 18, with the sections 13 with the comparatively higher compressibility and second sections 21 aligned, along the axis 5, with the sections 11 with the comparatively lower compressibility. In such an embodiment, a distribution of orientations of non-spherical pigment particles 25 in the first sections 23 of the coating layer 20 is different than a distribution of orientations of non-spherical pigment particles 25 in the second sections 11 of the coating layer 20. Hence, in this embodiment, the distribution of orientations of non-spherical pigment particles 25 in the first sections 23 of the coating layer 20 adjacent to or in vicinity of the sections 13 with the comparatively higher compressibility is different than a distribution of orientations of non-spherical pigment particles 25 in the second sections 21 of the coating layer 20 adjacent to or in vicinity of the sections 11 with the comparatively lower compressibility.

The distribution of orientations of the non-spherical pigment particles 25 in the first sections 23 of the coating layer 20 does not necessarily need to be uniform throughout the whole thickness of the coating layer 20. For instance, non-spherical pigment particles 25 in the portion of the coating layer 20 closest to the solid wood component 10 in these first sections 23 of the coating layer 20 may generally be oriented differently as compared to non-spherical pigment particles 25 in the portion of the coating layer 20 closest to the outer surface of the coating layer 20. As an example, the non-spherical pigment particles 25 in the topmost portion of the first sections 23 of the coating layer 20, i.e., close to the outer surface of the coating layer 20, may have an average orientation and distribution of orientation that is close to the average orientation and distribution of orientation of non-spherical pigment particles 25 in the first sections 21 of the coating layer 20, i.e., slightly tilted as seen in the view of FIG. 1C or substantially horizontal as seen in the view of FIG. 1D for flake-shaped pigment particles 25. However, in this example, the average orientation and distribution of orientation of non-spherical pigment particles 25 change when traveling from this outer surface and through the thickness of the coating layer 20, i.e., along the axis 5, and towards the inner surface of the coating layer 20 and the solid wood component 10. The non-spherical pigment particles 25 in this deeper portion of the coating layer 20 have an average orientation and distribution of orientation that is caused by the indentations or depressions in the solid wood component 10.

The solid wood component 10 is preferably a compressed solid wood component 10. Hence, the solid wood component 10 is compressed during the process of applying the coating layer 20 onto at least one side 12, 14, 16, 18 of the solid wood component 10 such as by extrusion.

The coating layer 20 could have varying thicknesses but is preferably quite thin. The visual effects of the coating layer 20 at least partly mimicking the wood grain of the solid wood component 10 generally become more evident the thinner the coating layer 20 may be. Hence, in an embodiment, the coating layer 20 preferably has an average thickness equal to or less than 10 mm, preferably equal to or less than 7.5 mm and more preferably equal to or less than 5 mm.

In a preferred embodiment, the coating layer 20 has an average thickness selected within a range of from 0.1 mm up to 5 mm and preferably within a range of from 0.25 mm up to 2.5 mm.

The thickness of the coating layer 20 as referred to herein is the average thickness of the coating layer 20 as applied to a side 12, 14, 16, 18 of the solid wood component 10. This means that the thickness of the coating layer 20 may differ from this average thickness. For instance, sections 23 of the coating layer 20 aligned with compressible sections 13 of the solid wood component 10 generally have a larger thickness as compared to the thickness of sections 21 of the coating layer 20 aligned with non-compressible or low-compressible sections 11 of the solid wood component 10. However, the average thickness as referred to herein is the average thickness of the coating layer 20 throughout its extension along the side 12, 14, 16, 18 of the solid wood component 10.

If the coating layer 20 is applied, such as extruded, to more than one side 12, 14, 16, 18 of the solid wood component 10 the coating layers 20 on these different sides 12, 14, 16, 18 may have the same or different average thicknesses.

The non-spherical pigment particles 25 are pigment particles 25 having a non-spherical shape. In a typical embodiment, the non-spherical particles 25 are elongated in at least one dimension, such as being rod-shaped, or could be elongated in two dimensions with a comparatively thinner third dimension, such as being flake-shaped. In either case, the pigment particles 25 could be separated or individual non-spherical pigment particles 25 or form non-spherical pigment aggregates of multiple particles.

In a preferred embodiment, the non-spherical pigment particles 25 are flake pigment particles 25, also referred to as flake-shaped pigment particles.

The non-spherical pigment particles 25 could be made of various materials but are preferably non-spherical metal pigment particles 25 made of metals including metal alloys. In a preferred embodiment, the non-spherical metal pigment particles 25 are non-spherical aluminum pigment particles, and more preferably aluminum flake pigment particles 25 or aluminum pigment flakes 25.

In an embodiment, the coating layer 20 comprises from 0.01 weight-% up to 1 weight-% of the non-spherical pigment particles.

The coating layer 20 comprises at least one thermoplastic polymer. Non-limiting, but illustrative, examples of such thermoplastic polymers include polyethylene terephthalate (PET), polystyrene (PS), polyamide (PA), poly(methyl methacrylate) (PMMA), polypropylene (PP), polyvinyl chloride (PVC), acrylonitrile butadiene styrene (ABS), styrene-acrylonitrile (SAN), polyacrylic acid (PAA), polylactic acid (PLA), polycarbonate (PC) and polyethylene (PE), such as high-density PE (HDPE) or low-density PE (LDPE). The at least one thermoplastic polymer is preferably selected from the group consisting of PET, PE and PP. A particular preferred version of PE is HDPE.

In an embodiment, the coating layer 20 is made of a composite material comprising the at least one thermoplastic polymer, the non-spherical pigment particles 25 and cellulosic material.

The cellulosic material of the coating layer 20 preferably comprises natural fibers.

The natural fibers used in accordance with the present invention are natural fibers that contain cellulose and, in many cases, lignin and/or hemicelluloses. The natural fibers may be produced by chemical pulping, mechanical pulping, chemo-mechanical pulping or mechanical milling/crushing of cellulosic or lignocellulosic raw materials. They are, typically, wood fibers produced by chemical pulping, mechanical pulping, chemo-mechanical pulping or mechanical milling/crushing of softwood or hardwood. Examples of such pulps are chemical pulp such as sulfate pulp or sulfite pulp, dissolving pulp, thermomechanical pulp (TMP), high temperature thermomechanical pulp (HTMP), mechanical fiber intended for medium density fiberboard (MDF-fiber), chemi-thermomechanical pulp (CTMP), high temperature chemi-thermomechanical pulp (HTCTMP), and a combination thereof. The fibers can also be produced by other methods such as steam explosion pulping, milling/crushing and/or from other cellulosic or lignocellulosic raw materials such as flax, jute, hemp, kenaf, bagasse, cotton, bamboo, straw or rice husk. It is also possible to use cellulosic material that is a mixture of fibers from different raw materials, such as a mixture of wood and any of the materials mentioned above.

The cellulosic material may alternatively consist of, or may comprise, milled wood fibers.

The cellulosic material may alternatively consist of, or may comprise, microfibrillated cellulose.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is or are usually required in order to make MFC manufacturing both energy efficient and sustainable. The cellulose fibers of the pulp used when producing MFC may, thus, be native or pre-treated enzymatically or chemically, for example to reduce the quantity of hemicellulose and/or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In an embodiment, the composite material comprises less than 50% by weight of the cellulosic material. In a particular embodiment, the composite material comprises less than 45% by weight of the cellulosic material, preferably less than 30% by weight of the cellulosic material, and more preferably less than 25% by weight of the cellulosic material. It is also possible to have a composite material comprising even less cellulosic material, such as less than 20% by weight of the cellulosic material or less than 15% by weight of the cellulosic material. For instance, the composite material could comprise less 10% by weight of the cellulosic material, less than 5% by weight of the cellulosic material or even less than 2.5% by weight of the cellulosic material.

In an embodiment, the cellulosic material in the composite material comprises cellulosic fibers having a length weighted average fiber length of up to 5 mm, preferably of up to 4 mm, more preferably of up to 3 mm, and most preferably up to 2 mm. In a particular embodiment, the length weighted average fiber length is equal to or below 1.7 mm, such as equal to or below 1.5 mm, preferably equal to or below 1 mm.

Length of fibers, such as cellulosic fibers, as referred to herein, is length weighted average fiber length. Length weighted average fiber length is calculated as the sum of individual fiber lengths squared divided by the sum of the individual fiber lengths as described in e.g., ISO 16065-1 or ISO 16065-2.

In an embodiment, the cellulosic material may be in the form of a powder. For instance, the cellulosic material may comprise cellulosic fibers that have been mechanically treated to a powder. It was found that if the cellulosic material is in the form of a powder it is easy to achieve a good dispersion and mixture with the at least one thermoplastic polymer and the non-spherical pigment particles 25.

In an embodiment, the powder particles have an average size (diameter) of up to 5 mm, preferably of up to 4 mm, more preferably of up to 3 mm, and most preferably up to 2 mm. In a particular embodiment, the average size (diameter) is equal to or below 1.7 mm, such as equal to or below 1.5 mm, preferably equal to or below 1 mm, or even smaller.

The solid wood component 10 of the composite product 1 is an engineered wood component 10 sometimes also referred to as wood core or engineered wood core. The solid wood component 10 can be of any kind of wood, e.g. softwood or hardwood or even bamboo. The solid wood component 10 can be any piece of wood, such as plank or board, including a piece of wood having holes, indentations, protrusions, tongue and grooves or other engineered structures.

In an embodiment, the solid wood component 10 is a thermally modified solid wood component 10.

In an embodiment, the cellulosic material is thermally modified cellulosic material, i.e., the cellulosic material has been thermally modified. In an embodiment, all cellulosic material is thermally modified cellulosic material. In another embodiment, a part of the cellulosic material is thermally modified cellulosic material. Thus, in an embodiment, the composite material comprises thermally modified cellulosic material and non-thermally modified cellulosic material.

Thermally modified wood as used herein, such as the thermally modified solid wood component 10 and/or thermally modified cellulosic material, is wood or cellulosic material having a composition of the cell wall material and its physical properties that are modified by the exposure of temperature higher than 160° C. and conditions of reduced oxygen availability. The solid wood component 10 or cellulosic material is altered in such way that at least some of the properties are permanently affected through the cross section of the solid wood component 10 or cellulosic material. In particular, the thermally modified wood has a lower number of hydroxyl groups (OH) as compared to non-thermally modified wood. In a particular embodiment, thermally modified wood is as defined in SID-CEN/TS 15679:2008 Thermally modified Timber-Definitions and characteristics.

Thermally modified wood is wood that has been modified by a controlled pyrolysis process of wood being heated, preferably in the absence of oxygen or at least in reduced oxygen atmosphere. Such a heat treatment induces chemical changes to the chemical structures of cell wall components, including lignin, cellulose and hemicellulose, in the wood resulting in increased durability. Low oxygen content during the heating process prevents the wood from burning at these high temperatures. Various heat treating processes are known to produce thermally modified wood including Westwood process, Plato process, Retification process, Les Bois Perdure process, Oil heat treatment and THERMOWOOD® process.

The heat treatment process removes certain organic compounds, often denoted volatile organic compounds (VOCs), which reduces the possibility for fungi and rot to thrive on the wood. In addition, the chemical changes to the chemical structures of the cell wall components make these less appetizing to fungi and insects. The heat treatment may, additionally, improve properties of the wood with respect to moisture, e.g., lower equilibrium moisture content, less moisture deformation and improved weather resistance.

The heat treatment is preferably performed for at least 5 hours, preferably at least 15 hours, more preferably at least 20 hours, such as at least 25 hours or even longer, such as at least 30 hours or at least 35 hours.

The coating layer 20 or the composite material may comprise additional components including, but not limited to, spherical pigment particles, such as absorption or white pigments, lubricants, such as extrusion lubrication, talcum, fillers, such as calcium carbonate, coupling agents, flame retardants and antimicrobial agents, such as fungicides.

The composite product 1 can be used for the production of many different products, such as cladding, decking, window and door profiles, light poles, jetties, joinery, furniture, joists, wall elements, sound barriers, fencing, products used in flooring, parquetry, paneling, etc.

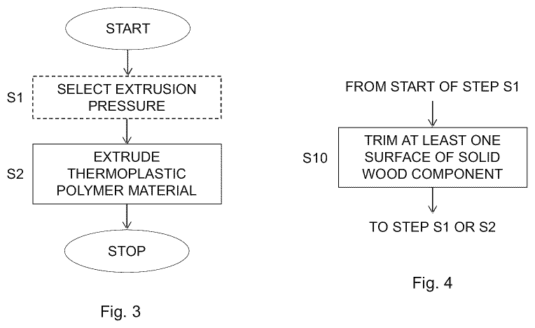

Another aspect of the invention relates to a method of producing a composite product 1, see FIGS. 2 and 3. The method comprises extruding, in step S2, a material 22 comprising at least one thermoplastic polymer and non-spherical pigment particles 25 onto at least one side 12, 14, 16, 28 of a solid wood component 10 having a wood grain at an extrusion pressure selected to form, on the at least one side 12, 14, 16, 18, a coating layer 20 having a surface pattern at least partly mimicking the wood grain.

A material 22 comprising the at least one thermoplastic polymer and the non-spherical pigment particles 25 is thereby extruded onto at least one side 12, 14, 16, 18 of the solid wood component 10 constituting the core of the resulting composite product 1. In an embodiment, the at least one thermoplastic polymer, the non-spherical pigment particles 25, and optionally other components as mentioned above, could be added to the extruder 100 as a pre-formed mixture, such as in the form of pellets comprising the at least one thermoplastic polymer, the non-spherical pigment particles 25 and optionally other components. Alternatively, the at least one thermoplastic polymer, the non-spherical pigment particles 25 and optionally other components could be added as separate components to the extruder 100 and then perform a mixing of the components inside the extruder 100. The extruder 100 typically comprises a hopper, into which the pre-mixed material 22 is fed or the separate components of the material 22 are fed. The material 22 is then conveyed forward onto the moving solid wood component 10 and forms, while applying pressure, the coating layer 20 on the at least one side 12, 14, 16, 18 of the solid wood component 10. This means that the at least one thermoplastic polymer and the non-spherical pigment particles 25 are extruded together in step S2 onto at least one side 12, 14, 16, 18 of the solid wood component 10 to form the coating layer 20 having a surface pattern at least partly mimicking the wood grain of the solid wood component 10.

The extrusion pressure used in step S2 is selected to form the surface pattern at least partly mimicking the wood grain of the solid wood component 10. This means that if a too low extrusion pressure is selected and used in step S2 the pressure will not be sufficient to compress any compressible sections 13 of the solid wood component 10 and no surface structures reflecting the wood grain, such as growth or annual rings or knots, will be formed in the at least one side 12, 14, 16, 18 of the solid wood component 10. In such a case, the orientation of the non-spherical pigment particles 25 will not be disturbed by such surface structures and the vast majority of the non-spherical pigment particles 25 will thereby have the tilted or almost up to horizontal orientation as indicated in sections 21 in FIG. 1C. However, by increasing the extrusion pressure, the compressible sections 13 of the solid wood component 10 will be depressed causing a local orientation distribution among the non-spherical pigment particles 25, see section 23 in FIG. 1C, which differs from the tilted or almost up to horizontal orientation as indicated in sections 21 in FIG. 1C. This local orientation of the non-spherical pigment particles 25 in the sections 23 aligned with indentations and depressions caused by the extrusion process and the applied extrusion pressure in sections 13 of the solid wood component 10 gives the coating layer 20 a surface pattern defined by the non-spherical pigment particles 25, or rather their individual orientations in the coating layer 20, and at least partly mimicking the wood grain of the solid wood component 10.

In an embodiment, the method comprises an additional step S1 as shown in FIG. 3. This step S1 comprises selecting the extrusion pressure at least partly based on a compressibility of the solid wood component 10. Thus, the extrusion pressure is selected at least partly based on characteristics of the solid wood component 10 including its compressibility and thereby hardness. The method then continues to step S2 where the extrusion is performed using the extrusion pressure selected in step S1. The actual extrusion pressure used in step S2 may also be at least partly dependent on other parameters than the compressibility of the solid wood component 10. Such other parameters may include the particular extruder 100 used in step S2, the type of material 22, the type of thermoplastic polymer(s) and/or the type of non-spherical pigment particles 25.

For many common wood types used as solid wood component 10 in composite products 1, the extrusion pressure is preferably at least 120 bar, more preferably at least 130 bar or even higher such as at least 140 bar or preferably at least 150 bar.

In an embodiment, the method may comprise an additional step S10 as shown in FIG. 4. This step S10 could be performed prior to step S2 or prior to step S1 in FIG. 3. Step S10 comprises trimming the at least one side 12, 14, 16, 18 of the solid wood component 10 using a thickness planner. In this embodiment, the material 22 is extruded in step S2 onto at least one trimmed side 12, 14, 16, 18 of the solid wood component 10.

The method as disclosed in FIG. 3 is preferably performed for producing a composite product 1 according to the embodiments as described herein.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1.-20. (canceled)

21. A composite product comprising:
a solid wood component; and
a coating layer on at least one side of the solid wood component,
wherein the at least one side of the solid wood component has a wood grain,
wherein the coating layer comprises at least one thermoplastic polymer and non-spherical pigment particles distributed within the coating layer, and
wherein the coating layer has a surface pattern at least partly mimicking the wood grain.

22. The composite product according to claim 21,
wherein the wood grain comprises sections with a comparatively higher compressibility and sections with a comparatively lower compressibility,
wherein the coating layer comprises first sections aligned, along an axis perpendicular to the at least one side, with the sections with the comparatively higher compressibility and second sections aligned, along the axis, with the sections with the comparatively lower compressibility, and
wherein non-spherical pigment particles in the first sections of the coating layer have a different average orientation in the coating layer than non-spherical pigment particles in the second sections of the coating layer.

23. The composite product according to claim 22, wherein the sections with the comparatively higher compressibility comprise earlywood and the sections with the comparatively lower compressibility comprise latewood.

24. The composite product according to claim 21,
wherein the wood grain comprises sections with a comparatively higher compressibility and sections with a comparatively lower compressibility,
wherein the coating layer comprises first sections aligned, along an axis perpendicular to the at least one side, with the sections with the comparatively higher compressibility and second sections aligned, along the axis, with the sections with the comparatively lower compressibility, and
wherein a distribution of orientations of non-spherical pigment particles in the first sections of the coating layer is different than a distribution of orientations of non-spherical pigment particles in the second sections of the coating layer.

25. The composite product according to claim 21, wherein the composite product comprises the coating layer on all sides of the solid wood component.

26. The composite product according to claim 21, wherein the solid wood component is a compressed solid wood component.

27. The composite according to claim 21, wherein the at least one side of the solid wood component is at least one trimmed side of the solid wood component.

28. The composite product according to claim 21, wherein the coating layer is an extruded coating layer.

29. The composite product according to claim 21, wherein the coating layer has an average thickness equal to or less than 10 mm.

30. The composite product according to claim 29, wherein the coating layer has an average thickness equal to or less than 5 mm.

31. The composite product according to claim 30, wherein the coating layer has an average thickness selected within a range of from 0.1 mm up to 5 mm.

32. The composite product according to claim 31, wherein the coating layer has an average thickness selected within a range of from 0.25 to 2.5 mm.

33. The composite product according to claim 21, wherein the coating layer comprises from 0.01 weight-% up to 1 weight-% of the non-spherical pigment particles.

34. The composite product according to claim 21, wherein the non-spherical pigment particles are flake pigment particles.

35. The composite product according to claim 34, wherein the non-spherical pigment particles are aluminum flake shaped pigment particles.

36. The composite product according to claim 21, wherein the non-spherical pigment particles are metal pigment particles.

37. The composite product according to claim 36, wherein the non-spherical pigment particles are aluminum pigment particles.

38. The composite product according to claim 21, wherein the at least one thermoplastic polymer is selected from the group consisting of polyethylene terephthalate (PET), polystyrene (PS), polyamide (PA), poly(methyl methacrylate) (PMMA), polypropylene (PP), polyvinyl chloride (PVC), acrylonitrile butadiene styrene (ABS), styrene-acrylonitrile (SAN), polyacrylic acid (PAA), polylactic acid (PLA), polycarbonate (PC) and polyethylene (PE).

39. The composite product according to claim 38, wherein the at least one thermoplastic polymer is selected from the group consisting of selected from the group consisting of PET, PE and PP.

40. The composite product according to claim 21, wherein the coating layer is of a composite material comprising the at least one thermoplastic polymer, the non-spherical pigment particles and cellulosic material.

41. A method of producing a composite product, the method comprising:
extruding a material comprising at least one thermoplastic polymer and non-spherical pigment particles onto at least one side of a solid wood component having a wood grain at an extrusion pressure selected to form, on the at least one side, a coating layer having a surface pattern at least partly mimicking the wood grain.

42. The method according to claim 41, further comprising selecting the extrusion pressure at least partly based on a compressibility of the solid wood component.

43. The method according to claim 41, wherein the extrusion pressure is at least 120 bar.

44. The method according to claim 43, wherein the extrusion pressure is at least 150 bar.

45. The method according to claim 41, further comprising trimming the at least one side of the solid wood component using a thickness planer.

46. A method of producing the composite product according to claim 21, the method comprising extruding the material comprising the at least one thermoplastic polymer and the non-spherical pigment particles onto the at least one side of the solid wood component to form the composite product.
